(19) United States
(12) Patent Application Publication
(10) Pub. No.: US 2007/0074708 A1
(43) Pub. Date: Apr. 5, 2007

(54) Blow-by gas recirculation system

(75) Inventors: Noriyasu Amano, Gamagori-city (JP); Hideaki Itakura, Nagoya-city (JP); Naoya Kato, Ama-gun (JP); Kazuhiro Hayashi, Nishikamo-gun (JP); Hidetoshi Uchiyama, Nagoya-city (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 11/529,278

(22) Filed: Sep. 29, 2006

(30) Foreign Application Priority Data
Sep. 29, 2005 (JP) 2005-283940

(51) Int. Cl. F02B 25/06

(52) U.S. Cl. 123/572

(57) ABSTRACT

A PCV valve is arranged in an outflow passage. An ECU controls rotation of a motor such that an opening degree of the PCV valve increases in response to an increase in an opening degree of a throttle valve. The outflow passage connects an interior of a head cover of an engine to a portion of an intake air passage located on a downstream side of the throttle valve. The outflow passage recirculates blow-by gas leaked from a combustion chamber into an interior of a crankcase to the portion of the intake air passage located on the downstream side of the throttle valve. An inflow passage connects the interior of the head cover to a portion of the intake air passage located on an upstream side of the throttle valve. The inflow passage conducts intake air from the intake air passage to the interior of the head cover.

### CROSS REFERENCE TO RELATED APPLICATION

This application is based on and incorporates herein by reference Japanese Patent Application No. 2005-283940 filed on Sep. 29, 2005.

### BACKGROUND OF THE INVENTION

1. Field of the Invention

The present invention relates to a blow-by gas recirculation system that recirculates blow-by gas into an intake air passage in an internal combustion engine.

2. Description of Related Art

In a previously proposed blow-by gas recirculation system (see, for example, Japanese Unexamined Patent Publication No. H06-229221), blow-by gas, which is leaked from a combustion chamber to an interior of a crankcase, is recirculated into a portion of an intake air passage, which is located on a downstream side of a throttle valve, by using a negative pressure generated in the intake air passage on the downstream side of the throttle valve. In this way, intake air is supplied from a portion of the intake air passage, which is located on an upstream side of the throttle valve, into an interior of a head cover or the interior of the crankcase of the internal combustion engine.

In such a blow-by gas recirculation system, a positive crankcase ventilation (PCV) valve, which serves as a flow quantity control valve, is provided in an outflow passage that conducts and discharges blow-by gas into the intake air passage. The PCV valve is opened by a negative pressure, which is generated in the intake air passage on the downstream side of the throttle valve, so that the blow-by gas is discharged into the intake air passage through the PCV valve.

However, the PCV valve is a differential pressure regulating valve. Thus, when the opening degree of the throttle valve is increased to cause a reduction in the negative pressure generated on the downstream side of the throttle valve, the opening degree of the PCV valve is reduced. As a result, as shown in FIG. 8, an intake air flow quantity, which is supplied into the interior of the head cover or of the crankcase, is reduced, and a quantity of the blow-by gas, which is discharged into the intake air passage, is reduced. Furthermore, when the opening degree of the throttle valve is increased in response to an increase in the engine load, the intake air flow quantity is increased. Thereby, the quantity of the generated blow-by gas is increased.

When the opening degree of the throttle valve is increased, the opening degree of the PCV valve, which is the differential pressure regulating valve, is reduced. Thus, when the opening degree of the throttle valve is increased to cause an increase in the blow-by gas, the increased blow-by gas on the downstream side of the throttle valve cannot be effectively discharged into the intake air passage. Therefore, the accumulated blow-by gas, which is not discharged through the PCV valve, causes an increase in the pressure in the interior of the crankcase. Then, the accumulated blow-by gas flows backward through an inflow passage, which conducts the intake air to the interior of the head cover or of the crankcase. Therefore, due to the backflow of the blow-by gas, the blow-by gas is eventually discharged into the portion of the intake air passage, which is located on the upstream side of the throttle valve. As a result, the throttle valve is exposed to the blow-by gas. Due to the exposure of the throttle valve to the blow-by gas, a deposit may adhere to the throttle valve. Also, the water contained in the blow-by gas may freeze at the low temperature to limit smooth rotation of the throttle valve.

Japanese Unexamined Patent Publication No. 2003-20925 (corresponding to U.S. Pat. No. 6,412,479 B1) and Japanese Unexamined Patent Publication No. 2003-214131 (corresponding to U.S. Pat. No. 6,772,744 B1) disclose a technique for heating with a heat source or for improving a thermal conductivity and thereby limiting the freezing caused by the blow-by gas. However, due to a relation between the heat quantity generated by the heat source and the external temperature, the freezing may not be sufficiently limited in some cases.

Japanese Unexamined Patent Publication No. H06-101442 discloses another technique, in which the above inflow passage is divided into a main passage and a bypass passage. However, even in this technique, the backflow of the blow-by gas into the intake air passage on the upstream side of the throttle valve may still occur.

### SUMMARY OF THE INVENTION

The present invention addresses the above disadvantage. Thus, it is an objective of the present invention to provide a blow-by gas recirculation system, which can limit exposure of a throttle valve to blow-by gas.

To achieve the objective of the present invention, there is provided a blow-by gas recirculation system for an internal combustion engine. The blow-by gas recirculation system includes a throttle valve, an inflow passage, an outflow passage, a flow quantity control valve and an opening degree control means. The throttle valve is arranged in an intake air passage of the internal combustion engine to adjust an intake air flow quantity in the intake air passage in conformity with an opening degree of the throttle valve. The inflow passage conducts intake air from a first portion of the intake air passage, which is located on an upstream side of the throttle valve, to an interior of a crankcase or an interior of a head cover of the internal combustion engine. The outflow passage discharges blow-by gas from the interior of the crankcase or the interior of the head cover to a second portion of the intake air passage, which is located on a downstream side of the throttle valve. The flow quantity control valve is arranged in the outflow passage and controls a flow quantity in the outflow passage. The opening degree control means is for controlling an opening degree of the flow quantity control valve. In one case, the opening degree control means may increase the opening degree of the flow quantity control valve in response to an increase in the opening degree of the throttle valve. In another case, the opening degree control means may increase the opening degree of the flow quantity control valve in response to an increase in the intake air flow quantity. In another case, the opening degree control means may increase the opening degree of the flow quantity control valve in response to an increase in a load of the internal combustion engine.

Furthermore, to achieve the objective of the present invention, there is also provided a blow-by gas recirculation system for an internal combustion engine. The blow-by gas recirculation system includes a throttle valve, an inflow passage, an outflow passage and a flow quantity control valve. The throttle valve is arranged in an intake air passage to adjust an intake air flow quantity in the intake air passage. The inflow passage conducts intake air from a first portion of the intake air passage, which is located on an upstream side of the throttle valve, to an interior of a crankcase or an interior of a head cover of the internal combustion engine. The outflow passage discharges blow-by gas from the interior of the crankcase or the interior of the head cover to a second portion of the intake air passage, which is located on a downstream side of the throttle valve. The flow quantity control valve is arranged in the outflow passage and controls a flow quantity in the outflow passage. In one case, a pressure loss of the outflow passage, which includes the flow quantity control valve, may be smaller than a pressure loss of the inflow passage. In another case, a connection, at which the inflow passage is connected to the first portion of the intake air passage, may be located on a downstream side of an upstream-side end of the throttle valve when the throttle valve is held in a fully opened position. Furthermore, the connection, at which the inflow passage is connected to the first portion of the intake air passage, may be located on an upstream side of the upstream-side end of the throttle valve when the throttle valve is held in a fully closed position.

### BRIEF DESCRIPTION OF THE DRAWINGS

The invention, together with additional objectives, features and advantages thereof, will be best understood from the following description, the appended claims and the accompanying drawings in which:

FIG. 1 is a schematic diagram showing a blow-by gas recirculation system according to a first embodiment of the present invention;

FIG. 2 is a schematic diagram showing a structure of a rotatable shaft of a throttle valve and of a PCV valve;

FIG. 3 is a schematic diagram showing a structure of a rotatable shaft of a throttle valve and a structure of a rotatable shaft of a PCV valve according to a second embodiment of the present invention;

FIGS. 4A-4F are diagrams showing various relationships of an opening degree of a PCV valve with respect to a throttle opening degree, an intake air flow quantity and an engine load;

FIG. 5 is a schematic diagram showing a blow-by gas recirculation system according to a third embodiment of the present invention;

FIG. 6 is a schematic diagram showing a blow-by gas recirculation system according to a fourth embodiment of the present invention;

FIG. 7A is a schematic diagram showing a blow-by gas recirculation system according to a fifth embodiment of the present invention;

FIG. 7B is an enlarged view of a circled section VIIB in FIG. 7A; and

FIG. 8 is a diagram showing a relationship between a throttle opening degree and an intake air flow quantity taken for PCV.

### DETAILED DESCRIPTION OF THE INVENTION

Various embodiments of the present invention will be described with reference to the accompanying drawings.

### First Embodiment

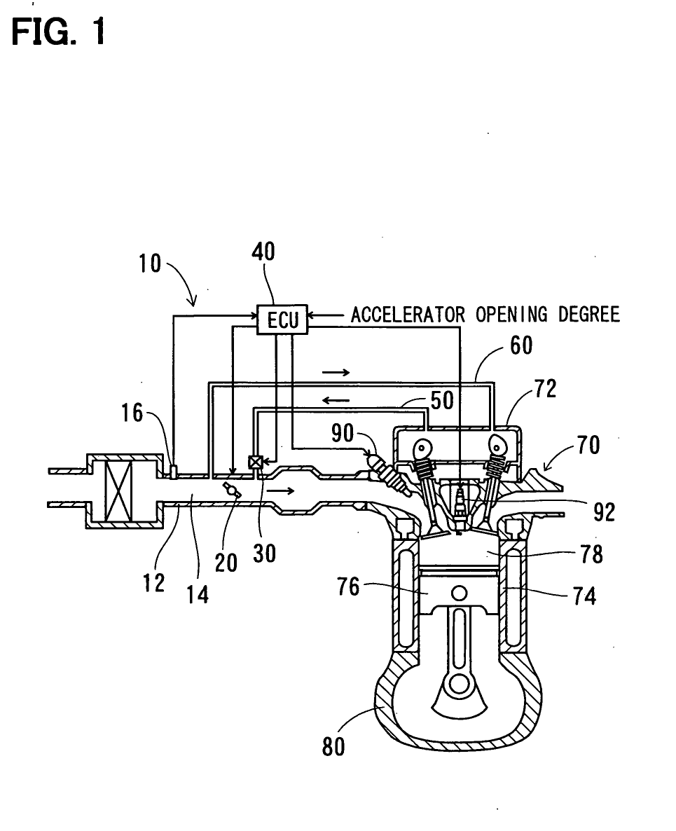

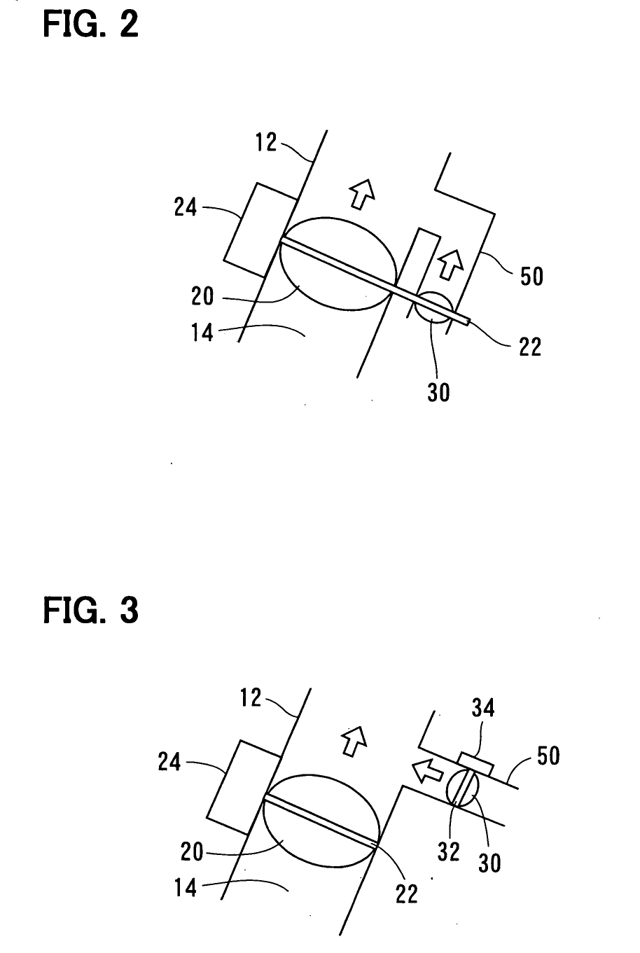

FIG. 1 shows a blow-by gas recirculation system 10 according to a first embodiment of the present invention. A flow sensor 16 is provided in an intake air pipe 12 to measure an intake air flow quantity (or simply referred to as an intake flow quantity) in an intake air passage 14, which is defined by the intake air pipe 12. As shown in FIG. 2, a throttle valve 20 is rotated by a motor 24 about an axis of a rotatable shaft 22.

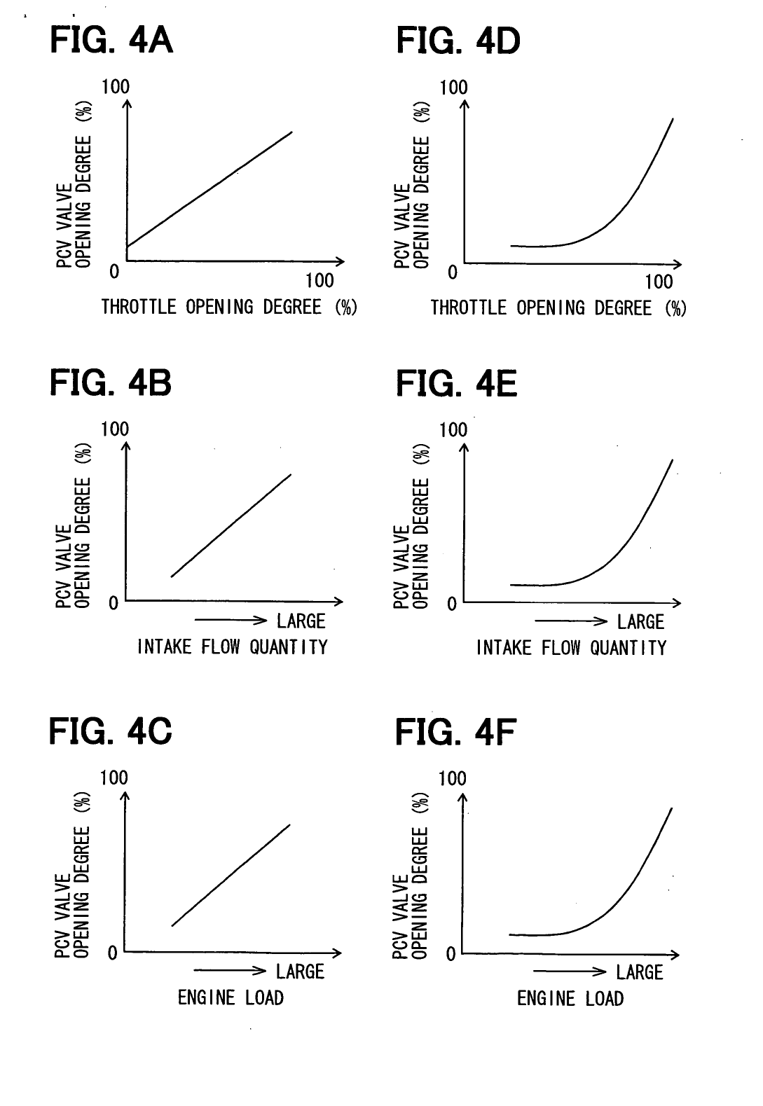

A PV valve (a butterfly valve) 30, which serves as a flow quantity control valve, is arranged in an outflow passage 50. As shown in FIG. 2, the PCV valve 30 is rotated by the motor 24 about the axis of the shaft 22, which is shared with the throttle valve 20. As shown in FIG. 4A, the PCV valve 30 is installed to the shaft 22 in such a manner that an opening degree of the PCV valve 30 increases in proportional to an opening degree of the throttle valve 20. A flow quantity in the outflow passage 50 is controlled according to the opening degree of the PCV valve 30.

The outflow passage 50 connects between a head cover 72 of an internal combustion engine 70 and a portion of the intake air passage 14, which is located on a downstream side of the throttle valve 20. The outflow passage 50 recirculates blow-by gas. Specifically, the blow-by gas may leak from a combustion chamber 78 into an interior of a crankcase 80 through a space between an inner wall of a cylinder 74 and a sliding part of a piston 76 in the engine 70. The leaked blow-by gas is conducted through the outflow passage 50 and is recirculated into the intake air passage 14 at the location downstream of the throttle valve 20. The interior of the crankcase 80 is communicated with an interior of the head cover 72 through a passage (not shown) in the cylinder 74.

An inflow passage 60 connects between the head cover 72 of the engine 70 and a portion of the intake air passage 14, which is located on an upstream side of the throttle valve 20. The inflow passage 60 conducts the intake air from the portion of the intake air passage 14, which is located on the upstream side of the throttle valve 20, to the interior of the head cover 72.

An engine control unit (ECU) 40, which serves as an opening degree control means, receives, for example, a measurement signal of the flow sensor 16 and a signal indicative of an accelerator opening degree. Furthermore, the ECU 40 controls the opening degree of the throttle valve 20 and the opening degree of the PCV valve 30 by electrically controlling rotation of the motor 24. The ECU 40 also controls opening and closing timing of an injector (a fuel injection valve) 90 and ignition timing of a spark plug 92.

In the first embodiment, the opening degree of the PCV valve 30 increases in proportional to the opening degree of the throttle valve 20 even when a quantity of the blow-by gas increases due to an increase in the opening degree of the throttle valve 20, an increase in the intake air flow quantity and/or an increase in the load of the engine. Thus, even when the opening degree of the throttle valve 20 increases to cause a decrease in a negative pressure in the portion of the intake air passage 14, which is located on the downstream side of the throttle valve 20, a backflow of the blow-by gas will not occur in the inflow passage 60, and thereby the blow-by gas can be effectively recirculated from the outflow passage 50 into the portion of the intake air passage 14, which is located on the downstream side of the throttle valve 20, through the PCV valve 30. In this way, it is possible to limit exposure of the throttle valve 20 to the blow-by gas. As a result, it is possible to limit adhesion of a deposit to the throttle valve 20 or freezing of the throttle valve 20 caused by water contained in the blow-by gas at the low temperature.

Furthermore, the opening degree of the PCV valve 30 increases in proportional to the opening degree of the throttle valve 20. Thus, the blow-by gas, which increases at the time of increasing the opening degree of the throttle valve 20, can be sufficiently recirculated into the portion of the intake air passage 14, which is located on the downstream side of the throttle valve 20. In this way, it is possible to limit degradation of lubricant oil of the engine 70.

In the first embodiment, the throttle valve 20 and the PCV valve 30 are driven by the single motor 24. Thus, the number of the required motors can be advantageously reduced. Furthermore, the rotatable shaft of the throttle valve 20 and the rotatable shaft of the PCV valve 30 are directly joined together, i.e., are formed together. Thus, with the above simple structure, it is possible to increase the opening degree of the PCV valve 30 in response to the increase in the opening degree of the throttle valve 20.

### Second Embodiment

According to a second embodiment, as shown in FIG. 3, a rotatable shaft 32 of the PCV valve 30 is different from the rotatable shaft 22 of the throttle valve 20. Furthermore, the PCV valve 30 is rotated by a motor 34, which is different from the motor 24 of the throttle valve 20. The ECU 40 controls rotation of the motor 34 in such a manner that the opening degree of the PCV valve 30 increases in response to an increase in the opening degree of the throttle valve 20.

According to the second embodiment, the PCV valve 30 has the rotatable shaft 32, which is different from the rotatable shaft 22 of the throttle valve 20, and is rotated by the motor 34, which is different from the motor 24 of the throttle valve 20. Thus, as shown in FIGS. 4B-4F, the opening degree of the PCV valve 30 can be controlled in various ways with respect to the throttle opening degree, the intake air flow quantity or the load of the engine (or simply referred to as an engine load). Specifically, in FIG. 4B, the opening degree of the PCV valve 30 increases in proportional to the intake air flow quantity. In FIG. 4C, the opening degree of the PCV valve 30 increases in proportional to the engine load. In FIG. 4D, a rate of change in the opening degree of the PCV valve 30 becomes relatively small when the throttle opening degree becomes relatively small, and the rate of change in the opening degree of the PCV valve 30 becomes relatively large when the throttle opening degree becomes relatively large. In FIG. 4E, the rate of change in the opening degree of the PCV valve 30 becomes relatively small when the intake air flow quantity becomes relatively small, and the rate of change in the opening degree of the PCV valve 30 becomes relatively large when the intake air flow quantity becomes relatively large. In FIG. 4F, a rate of change in the opening degree of the PCV valve 30 becomes relatively small when the engine load becomes relatively small, and the rate of change in the opening degree of the PCV valve 30 becomes relatively large when the engine load becomes relatively large. The ECU 40 measures the throttle opening degree based on a control signal, which controls the rotation of the motor 24, or based on a measurement signal of an angle sensor (not shown). Furthermore, the ECU 40 measures the intake air flow quantity based on the measurement signal of the flow sensor 16. Also, the ECU 40 measures the engine load based on the injection quantity of the injector 90 or based on the accelerator opening degree.

### Third and Fourth Embodiments

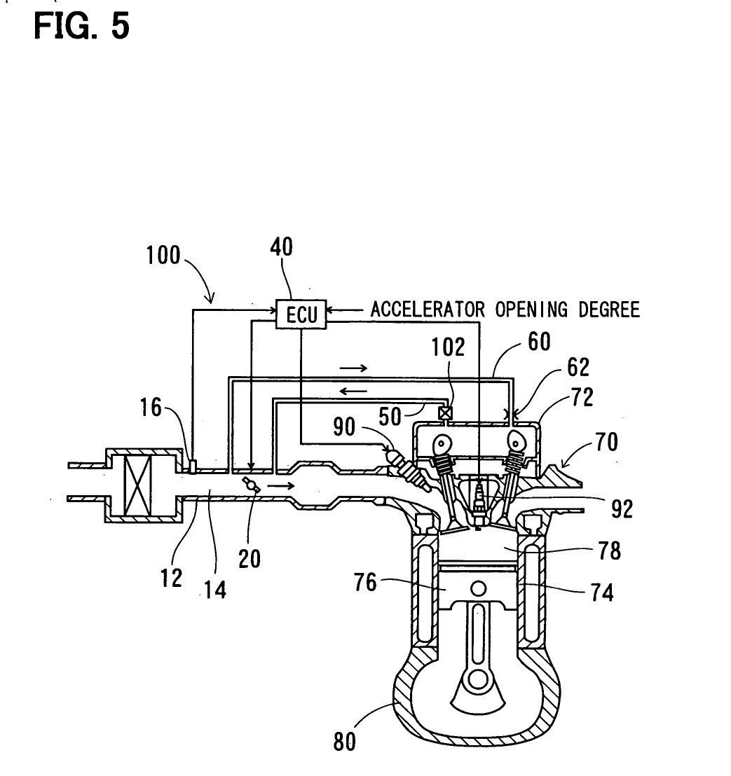

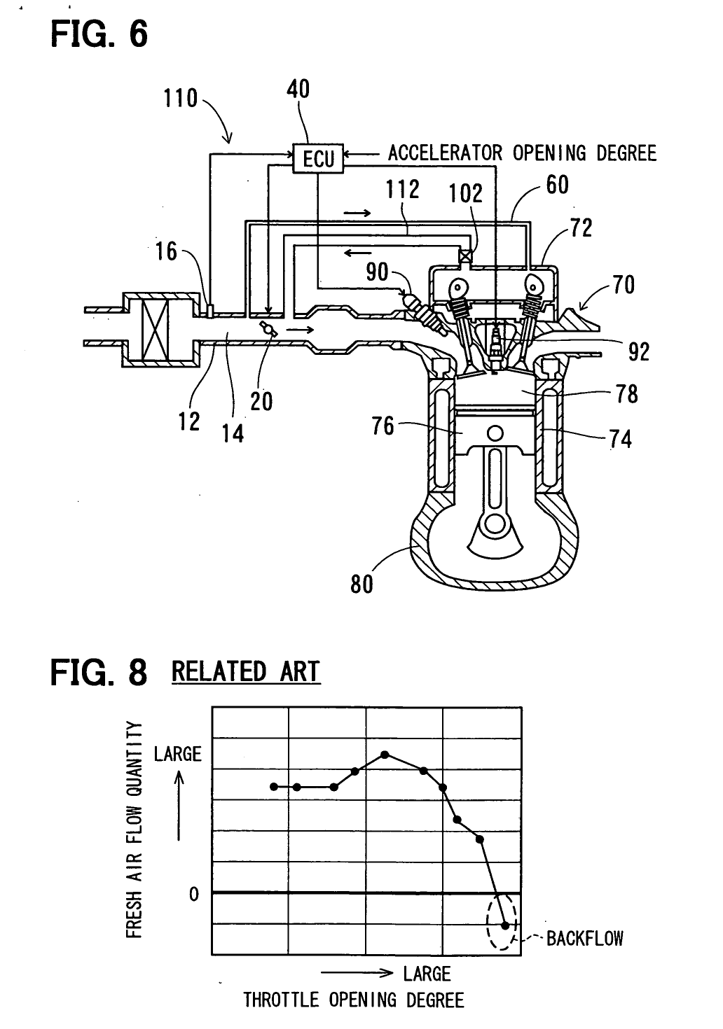

FIG. 5 shows a third embodiment of the present invention, and FIG. 6 shows a fourth embodiment of the present invention. In the following description, components similar to those of the above embodiments will be indicated by the same numerals.

In a blow-by gas recirculation system 100 of the third embodiment shown in FIG. 5, a PCV valve 102, which serves as a flow quantity control valve, is a differential pressure regulating valve. A choke 62 is formed in the inflow passage 60, so that even though the passage cross sectional area of the outflow passage 50 and the passage cross sectional area of the inflow passage 60 are the same, a pressure loss of the outflow passage 50 is made smaller than a pressure loss of the inflow passage 60 at the time of fully opening the PCV valve 102. Thus, even in the case where the throttle opening degree is relatively large, and the negative pressure in the portion of the intake air passage 14, which is located on the downstream side of the throttle valve 20, is relatively small, the blow-by gas can be more easily conducted in the outflow passage 50 in comparison to the inflow passage 60. Thereby, the blow-by gas can be recirculated into the portion of the intake air passage 14, which is located on the downstream side of the throttle valve 20, while limiting the backflow of the blow-by gas into the inflow passage 60.

In a blow-by gas recirculation system 110 of FIG. 6 according to the fourth embodiment, the PCV valve 102 is a differential pressure regulating valve like in the third embodiment. Furthermore, the passage cross sectional area of an outflow passage 112 is made larger than the passage cross sectional area of the inflow passage 60. Thus, even in the case where the throttle opening degree is relatively large, and the negative pressure in the portion of the intake air passage 14, which is located on the downstream side of the throttle valve 20, is relatively small, the blow-by gas can be more easily conducted in the outflow passage 112 in comparison to the inflow passage 60. Thereby, the blow-by gas can be recirculated into the portion of the intake air passage 14, which is located on the downstream side of the throttle valve 20, while limiting the backflow of the blow-by gas into the inflow passage 60.

### Fifth Embodiment

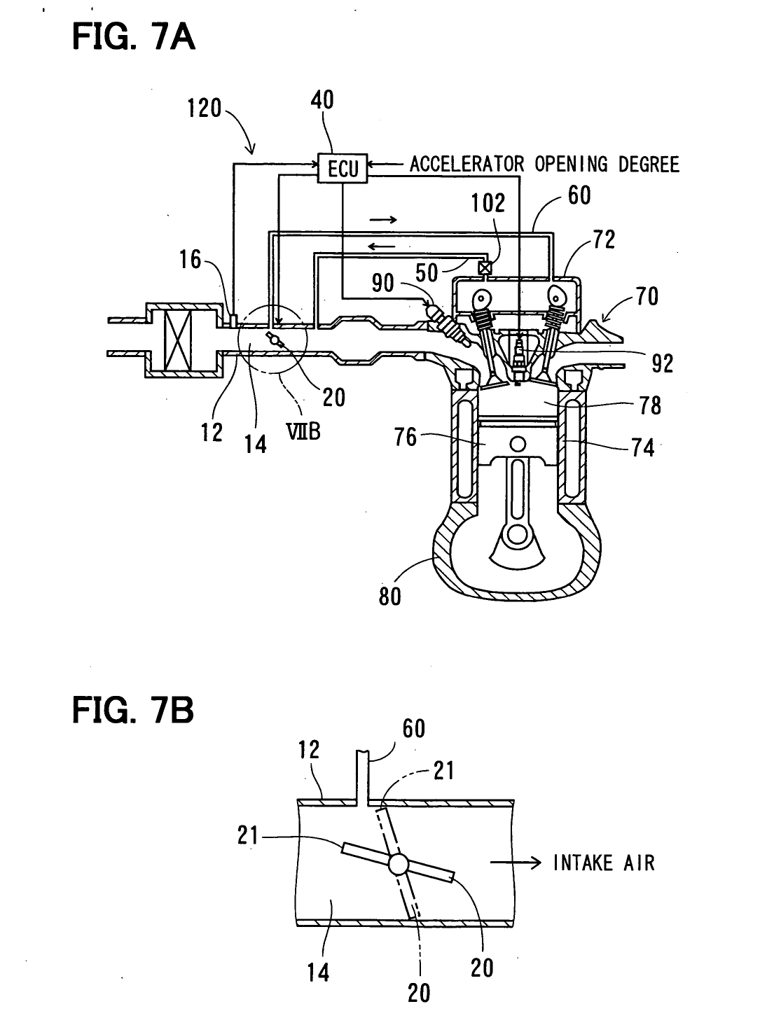

FIG. 7 shows a fifth embodiment of the present invention. In the following description, components similar to those of the above embodiments will be indicated by the same numerals.

In a blow-by gas recirculation system 120 according to the fifth embodiment, the PCV valve 102 is the differential pressure regulating valve, like in third and fourth embodiments.

A connection, at which the inflow passage 60 is connected to the corresponding portion of the intake air passage 14, is located on a downstream side of an upstream-side end 21 of the throttle valve 20 when the throttle valve 20 is held in a fully opened position (indicated by a solid line in FIG. 7B). Thus, in the case where the throttle opening degree is relatively large, and the negative pressure in the portion of the intake air passage 14, which is located on the downstream side of the throttle valve 20, is relatively small, even when the backflow of the blow-by gas occurs from the inflow passage 60 into the intake air passage 14, the blow-by gas flows without contacting the throttle valve 20 toward the downstream side due to the intake air flow.

Furthermore, the connection, at which the inflow passage 60 is connected to the corresponding portion of the intake air passage 14, is located on an upstream side of the upstream-side end 21 of the throttle valve 20 when the throttle valve 20 is held in a fully closed position (indicated by a dot-dot-dash line in FIG. 7B). When the opening degree of the throttle valve 20 is relatively small, the negative pressure in the portion of the intake air passage 14, which is located on the downstream side of the throttle valve 20, is relatively large. Thus, the backflow of the blow-by gas into the inflow passage 60 does not occur, and the blow-by gas is outputted from the outflow passage 50 into the portion of the intake air passage 14, which is located on the downstream side of the throttle valve 20.

In this way, it is possible to limit exposure of the throttle valve 20 to the blow-by gas regardless of the opening degree of the throttle valve 20. As a result, it is possible to limit adhesion of a deposit to the throttle valve 20 or freezing of the throttle valve 20 caused by water contained in the blow-by gas at the low temperature.

(Modification)

In the first embodiment, the ECU 40, which serves as the opening degree control means, controls the motor 24 to control the opening degree of the PCV valve 30. Alternatively, even in a case where the opening degree of the throttle valve changes synchronously with the accelerator opening degree through, for example, a wire-link, the opening degree of the PCV valve 30 can be increased in proportional to the opening degree of the throttle valve 20 through use of the opening degree control means, in which the rotatable shaft of the PCV valve 30 and the rotatable shaft of the throttle valve 20 are directly joined.

Additional advantages and modifications will readily occur to those skilled in the art. The invention in its broader terms is therefore not limited to the specific details, representative apparatus, and illustrative examples shown and described.

What is claimed is:

1. A blow-by gas recirculation system for an internal combustion engine, the blow-by gas recirculation system comprising:
a throttle valve that is arranged in an intake air passage of the internal combustion engine to adjust an intake air flow quantity in the intake air passage in conformity with an opening degree of the throttle valve;
an inflow passage that conducts intake air from a first portion of the intake air passage, which is located on an upstream side of the throttle valve, to an interior of a crankcase or an interior of a head cover of the internal combustion engine;
an outflow passage that discharges blow-by gas from the interior of the crankcase or the interior of the head cover to a second portion of the intake air passage, which is located on a downstream side of the throttle valve;
a flow quantity control valve that is arranged in the outflow passage and controls a flow quantity in the outflow passage; and
an opening degree control means for controlling an opening degree of the flow quantity control valve in such a manner that the opening degree control means increases the opening degree of the flow quantity control valve in response to an increase in the opening degree of the throttle valve.

2. The blow-by gas recirculation system according to claim 1, wherein the flow quantity control valve is a butterfly valve.

3. The blow-by gas recirculation system according to claim 2, wherein a rotatable shaft of the flow quantity control valve and a rotatable shaft of the throttle valve are directly joined together.

4. The blow-by gas recirculation system according to claim 1, further comprising a motor that drives both of the flow quantity control valve and the throttle valve, wherein the opening degree control means controls rotation of the motor.

5. The blow-by gas recirculation system according to claim 1, further comprising a motor that drives the flow quantity control valve, wherein the opening degree control means controls rotation of the motor.

6. The blow-by gas recirculation system according to claim 1, wherein the opening degree control means controls the opening degree of the flow quantity control means in proportional to the opening degree of the throttle valve.

7. The blow-by gas recirculation system according to claim 1, wherein:
the opening degree control means makes a relatively small rate of change in the opening degree of the flow quantity control valve when the opening degree of the throttle valve become relatively small; and
the opening degree control means makes a relatively large rate of change in the opening degree of the flow quantity control valve when the opening degree of the throttle valve become relatively large.

8. A blow-by gas recirculation system for an internal combustion engine, the blow-by gas recirculation system comprising:
a throttle valve that is arranged in an intake air passage of the internal combustion engine to adjust an intake air flow quantity in the intake air passage in conformity with an opening degree of the throttle valve;
an inflow passage that conducts intake air from a first portion of the intake air passage, which is located on an upstream side of the throttle valve, to an interior of a crankcase or an interior of a head cover of the internal combustion engine;
an outflow passage that discharges blow-by gas from the interior of the crankcase or the interior of the head cover to a second portion of the intake air passage, which is located on a downstream side of the throttle valve;
a flow quantity control valve that is arranged in the outflow passage and controls a flow quantity in the outflow passage; and
an opening degree control means for controlling an opening degree of the flow quantity control valve in such a manner that the opening degree control means increases the opening degree of the flow quantity control valve in response to an increase in the intake air flow quantity.

9. The blow-by gas recirculation system according to claim 8, wherein the opening degree control means controls the opening degree of the flow quantity control valve in proportional to the intake air flow quantity.

10. The blow-by gas recirculation system according to claim 8, wherein:
the opening degree control means makes a relatively small rate of change in the opening degree of the flow quantity control valve when the intake air flow quantity becomes relatively small; and
the opening degree control means makes a relatively large rate of change in the opening degree of the flow quantity control valve when the intake air flow quantity becomes relatively large.

11. A blow-by gas recirculation system for an internal combustion engine, the blow-by gas recirculation system comprising:
a throttle valve that is arranged in an intake air passage of the internal combustion engine to adjust an intake air flow quantity in the intake air passage in conformity with an opening degree of the throttle valve;
an inflow passage that conducts intake air from a first portion of the intake air passage, which is located on an upstream side of the throttle valve, to an interior of a crankcase or an interior of a head cover of the internal combustion engine;
an outflow passage that discharges blow-by gas from the interior of the crankcase or the interior of the head cover to a second portion of the intake air passage, which is located on a downstream side of the throttle valve;
a flow quantity control valve that is arranged in the outflow passage and controls a flow quantity in the outflow passage; and
an opening degree control means for controlling an opening degree of the flow quantity control valve in such a manner that the opening degree control means increases the opening degree of the flow quantity control valve in response to an increase in a load of the internal combustion engine.

12. The blow-by gas recirculation system according to claim 11, wherein the opening degree control means controls the opening degree of the flow quantity control valve in proportional to a load of the internal combustion engine.

13. The blow-by gas recirculation system according to claim 11, wherein:
the opening degree control means makes a relatively small rate of change in the opening degree of the flow quantity control valve when a load of the internal combustion engine becomes relatively small; and
the opening degree control means makes a relatively large rate of change in the opening degree of the flow quantity control valve when the load of the internal combustion engine becomes relatively large.

14. A blow-by gas recirculation system for an internal combustion engine, the blow-by gas recirculation system comprising:
a throttle valve that is arranged in an intake air passage to adjust an intake air flow quantity in the intake air passage;
an inflow passage that conducts intake air from a first portion of the intake air passage, which is located on an upstream side of the throttle valve, to an interior of a crankcase or an interior of a head cover of the internal combustion engine;
an outflow passage that discharges blow-by gas from the interior of the crankcase or the interior of the head cover to a second portion of the intake air passage, which is located on a downstream side of the throttle valve; and
a flow quantity control valve that is arranged in the outflow passage and controls a flow quantity in the outflow passage, wherein a pressure loss of the outflow passage, which includes the flow quantity control valve, is smaller than a pressure loss of the inflow passage.

15. The blow-by gas recirculation system according to claim 14, wherein a passage cross sectional area of the inflow passage is smaller than a passage cross sectional area of the outflow passage.

16. The blow-by gas recirculation system according to claim 14, wherein the inflow passage includes a choke.

17. A blow-by gas recirculation system for an internal combustion engine, the blow-by gas recirculation system comprising:
a throttle valve that is arranged in an intake air passage of the internal combustion engine to adjust an intake air flow quantity in the intake air passage in conformity with an opening degree of the throttle valve;
an inflow passage that conducts intake air from a first portion of the intake air passage, which is located on an upstream side of the throttle valve, to an interior of a crankcase or an interior of a head cover of the internal combustion engine;
an outflow passage that discharges blow-by gas from the interior of the crankcase or the interior of the head cover to a second portion of the intake air passage, which is located on a downstream side of the throttle valve; and
a flow quantity control valve that is arranged in the outflow passage and controls a flow quantity in the outflow passage, wherein:
a connection, at which the inflow passage is connected to the first portion of the intake air passage, is located on a downstream side of an upstream-side end of the throttle valve when the throttle valve is held in a fully opened position; and
the connection, at which the inflow passage is connected to the first portion of the intake air passage, is located on an upstream side of the upstream-side end of the throttle valve when the throttle valve is held in a fully closed position.
